(19) United States
(12) Patent Application Publication
(10) Pub. No.: US 2010/0057772 A1
(43) Pub. Date: Mar. 4, 2010

(54) AUTOMATIC DETERMINATION OF AN ENTITY'S SEARCHABLE SOCIAL NETWORK USING ROLE-BASED INFERENCES

(75) Inventors: Dragos Manolescu, Kirkland, WA (US); Erik Meijer, Mercer Island, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/200,936

(22) Filed: Aug. 29, 2008

(51) Int. Cl. G06F 17/30

(52) U.S. Cl. 707/103 R; 707/E17.055

(57) ABSTRACT

Techniques and systems for determining a first entity's social network are provided herein. Data is extracted from one or more data sources associated with the first entity. Once data is extracted, a role of a second entity may be inferred using inference algorithms, rules, keywords, and/or tags in the data extracted. The first entity's social network may be determined by linking the first entity to the second entity and the second entity's role(s) in relation to the first entity. It will be appreciated that the first entity may also search his/her/its network and/or other entities' social networks if the first entity has been granted access by the other entities, for example. Additionally, information about entities found during the first entity's search may be added to a data source associated with the first entity.

### BACKGROUND

A social network refers to a set of entities that interact and exchange information in a social relationship. Entities include, for example, people, teams, groups, organizations, and countries, while social relationships refer to friendship, employment, or other relationships between these entities.

A growing number of applications attempt to capture an entity's social networks. This spans from applications aimed at getting college students oriented, to finding medical doctors. While each of these applications leverages social networks, typically entities describe their individual networks manually for each application.

There are several problems with manually describing social networks. It entails duplicating existing knowledge, and as such it is time consuming and tedious. It does not scale, so as the number of social networks increase, entities will spend an increasing amount of time describing their networks. Additionally, it is incomplete because, besides obvious members, an entity's social networks also include former colleagues, collaborators, and entities with which interaction is infrequent. These entities are rarely included in a social network when the social network is described manually.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to a first aspect, a method for inferring a first entity's social network is provided. The method includes extracting data from one or more data sources (e.g. an email, calendar, internet, phonebook, etc.) associated with the first entity. The data sources may be personal to the entity and/or public information. To ensure the protection of personal data, the first entity may select which data source(s) data is extracted from, and/or the data extracted may be secured (e.g., using encryption, password protection, etc.) so that other entities may not access the extracted data. The method also includes identifying or otherwise discovering a second entity and inferring a role (e.g., co-author, co-worker, mother, brother, etc.) of the second entity in relation to the first entity as a function of the data extracted. Once the role of the second entity is inferred, a social network may be determined by linking the first entity to the second entity and the second entity's role in relation to the first entity.

According to another aspect, a system for determining a first entity's social network is provided herein. The system includes a crawler that is configured to collect data from one or more data sources associated with the first entity and a classifier configured to infer a role and/or roles of a second entity in relation to the first entity. The system also includes a storage component configured to determine the first entity's social network by linking the first entity to the second entity and the second entity's role(s) in relation to the first entity. It will be appreciated that the classifier may also be configured to detect the second entity prior to inferring the role(s) of the second entity in relation to the first entity. Additionally, the system may include a notification component configured to notify the crawler when changes are made in the one or more data sources, so that the social network may be automatically updated.

After a social network has been established for the first entity, the social network may be published on a (password protected, or otherwise security enabled) website or made available through a service, wherein the first entity may search his/her/its network. For example, if the first entity is looking to co-author a book, he might search his social network to find people that have co-authored books with him in the past. Additionally, the first entity may search other entities' social networks (that are managed by interoperable services). The ability to search other entities' social networks may be limited, for example, by an entity's security limits on his/her/its social network, the type of search being conducted, and/or limits defined by the entity conducting the searching. It will be appreciated that the first entity may select an entity found in a search of another entity's social network, and that entity may be added to the first entity's social network and/or a data source(s) associated with the first entity, such as a phonebook.

The techniques disclosed herein are designed to reduce the amount of time an entity spends describing his/her/its social network. The breath/coverage of an entity's social network may also be improved, while automatically keeping the social network up-to-date. Additionally, the techniques disclosed herein aid an entity in conducting searches across other entities' social networks.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of determining a first entity's social network.

FIG. 2 is a component block diagram illustrating an exemplary system for determining a first entity's social network.

FIG. 3 is an illustration of an exemplary computer-readable medium comprising processor-executable instructions configured to embody one or more of the provisions set forth herein.

FIG. 4 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

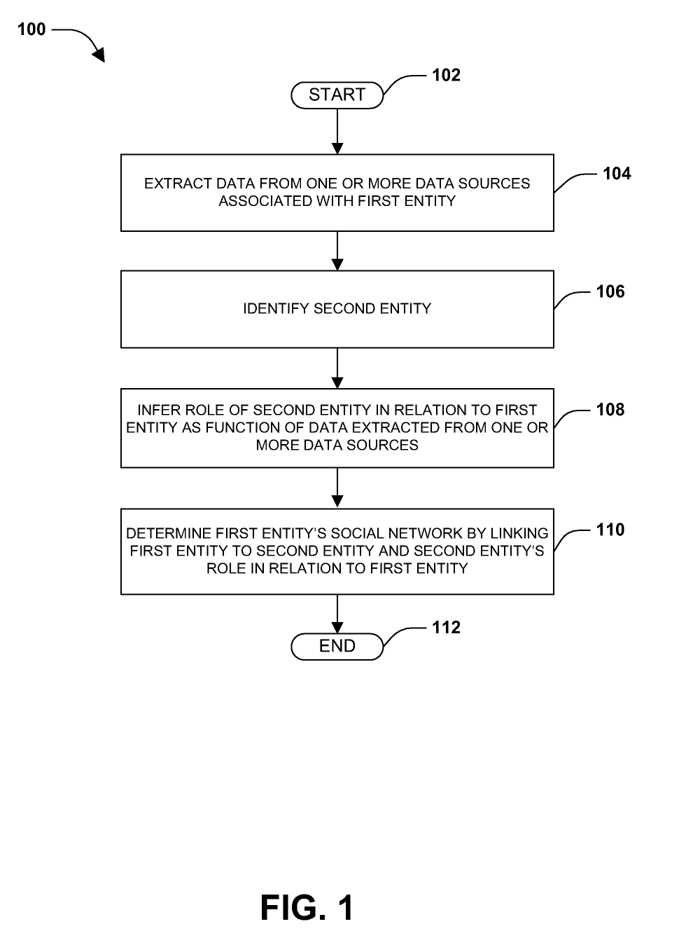

Turning initially to FIG. 1, an exemplary methodology 100 is illustrated for determining a first entity's social network. The example method 100 begins at 102, and data is extracted from one or more data sources associated with the first entity at 104. The data sources may be personal and/or public and may include, for example: private electronic documents (word processor documents, images, etc.); private resources (phone logs, instant messenger logs, etc.); personal devices (phones, personal digital assistants, etc.); personal information management systems (e.g., email applications, phonebooks, calendar applications, to-do list applications, etc.); corporate electronic documents; corporate resources (e.g., digital libraries); corporate information systems (e.g., a company network; company storage drive, etc.); public electronic documents; public resources (e.g., internet pages); and/or search results (from company intranet, public internet, etc.). The extracted data may include, for example, the names of other entities, entities' addresses, entities' titles, and/or the context of the social relationship, such as the days and times of day the first entity has met with and/or spoken to the other entities, the relationship between entities (e.g., co-author, reviewer, event attendee, etc.). The data extracted may be limited, for example, as a function of data sources the first entity selects to extract data from. The data extracted may also be limited to a particular type of data, such as data that has not been extracted before (e.g., new or modified data).

It will be appreciated that data may be extracted on demand (e.g. when the first entity clicks an “extract information” button) and/or automatically. In one embodiment, the data is initially extracted on demand when the first entity selects an “extract data” button, causing the data in the data source(s) to be extracted, and additional data is periodically extracted automatically to update the data previously extracted. Data may be extracted automatically from the data source(s), for example, by monitoring ping servers used in data sources (e.g., APIs) and crawling feeds in response to ping events. For example, the first entity may add a new contact to his phonebook, and the phonebook application may send a ping to notify a crawler (e.g., registered observer) to crawl the phonebook and extract the new contact. For data sources that do not provide regular pings, scheduled crawling may be performed. For example, every month the crawler may search a digital library (using the first entity's name as a search term) to extract new entities related to the first entity through written collateral such as articles, books, commentaries, and so on.

At 106, a second entity is identified. The second entity may be identified manually and/or automatically. The second entity may be identified automatically, for example, as a function of the data (i.e., context of the social relationship) extracted from the data sources. In one example, inference algorithms, such as those designed using machine learning techniques, natural language processing, and/or artificial intelligence are used to detect a second entity. For example, if the data source is a digital library, the algorithms could infer that the second entity is a co-author because his name appears next to the first entity's name in the author tag of a book. Similarly, if the data source is the Internet, the algorithms could infer that the second entity is a workshop committee fellow because his name appears on a workshop's web page, under a “Program Committee” heading.

Additionally, the second entity may be identified manually by the first entity. In one embodiment, the first entity selects the second entity from a list of entities and/or searches (a website wherein a plurality of other entities' social networks are managed) to find the second entity. It will be appreciated, however, that while 106 is illustrated as following 104, the second entity may be identified before data is extracted from a data source, such as when the second entity is identified manually. If the second entity is identified before data is extracted, the data extracted may be a function of the second entity (e.g., a phonebook entry that includes the second entity's name, emails that include correspondence with the second entity, etc.). That is, the acts presented may occur in an order different from that illustrated.

At 108, a role of the second entity, in relation to the first entity, is inferred as a function of the data extracted from the data sources at 104. It will be appreciated that the term “role” is used in a broad sense herein and throughout the disclosure to describe, among other things, rights, obligations, and/or expected behavior patterns of one entity to another entity. The role(s) may include: biological roles (e.g., mother, sister, cousin, etc.); business roles (e.g., co-worker, supervisor, client, etc.); social hierarchical roles (e.g., close friend, direct supervisor, etc.); and/or social roles (e.g., friend, teammate, etc.), for example. Rules and inference algorithms (more complex than those used to identify the second entity) may also and/or instead of a predefined list be used to infer the second entity's role in relation to the first entity. Inference algorithms may be designed using artificial intelligence (e.g., neural networks, fuzzy logic, expert systems, etc.), for example, to detect a role of the second entity with respect to the first entity as a function of in the context from which the data is extracted. Inference algorithms may also be designed to infer the nature of the dialogue between the second entity and the first entity. Additionally, the inference algorithms may use the frequency of contact and/or the immediacy of a response, for example, to infer the role of the second entity in relation to the first entity. For example, the inference algorithms may use emails to detect that the second entity the domain name@fredgeorgemd.com, responds quickly to emails sent by the first entity, and often uses the term “Dr.” when addressing the first entity. From these detections, the inference algorithms may infer that the second entity is a potential patient of the first entity.

It will be appreciated that additional data may be searched for and/or extracted from data sources if the second entity is identified automatically at 106, using natural language processing algorithms. For example, a first entity may have a calendar entry (in a data source) that repeats bi-weekly, and a second entity's name is identified based on terms in the calendar entry. Using the name of the second entity, a search of the internet (e.g., another data source) may be conducted, and search results may indicate (e.g., using link extraction techniques) that a cleaning company in the same geographical region as the first entity (as a function of information known about the first entity, the location of a majority of the first entity's contacts, etc.) matches the name of the second entity. An inference may then be made that that first entity uses the second entity for cleaning services.

Other mechanisms have also been contemplated to identify the second entity automatically and/or infer the second entity's role in relation to the first entity. Standardized fields, for example, in PIM systems may be used identify the second entity and/or infer the second entity's role. In one example, the second entity is identified according to text in a “name” field of a phonebook entry and the second entity's role is identified as a function of text in a “title” field of the phonebook entry. Additionally, tags in the data extracted may identify the type of data and/or assist in the identification.

In one embodiment, the user may accept, reject, and/or modify the inferences made about the second entity's role in relation to the first entity. For example, if the inferences infer that the second entity is the first entity's tax accountant the name of the second entity along with his inferred role as the first entity's tax accountant may be displayed to the first entity. The first entity may acknowledge (e.g., by selecting an “accept” button) that the second entity is his tax accountant, but he may also add (or select from a predefined list of roles) that the second entity is his cousin. Additionally, the user may reject the second entity, such as when the second entity is identified automatically (e.g., blacklisting the second entity from future identifications and from the first entity's social network).

It will be appreciated that where a user may accept, reject, and/or modify the inferences made, either at 106 or 108, the first entity's input may be used to fine-tune the algorithms, wherein the algorithms use artificial intelligence techniques, so that the inferences made are more accurate in the future, for example. It will further be appreciated that where roles are stored on a predetermined list (and selected based on inferences made), roles inputted by the first entity may be added to the predetermined list.

At 110, the first entity's social network is determined by linking the first entity to the second entity and the second entity's role in relation to the first entity. In one example, the second entity, the second entity's role(s) in relation to the first entity, and supplemental information about the second entity, such as contact information, geographic location, and/or demographic information (age, birthday, sex, etc.), about the entity (detected as a function of the data extracted from the one or more data sources) is stored in a (secure) database (e.g., encrypted to prevent the information for being disseminated). It will be appreciated that here, as elsewhere in this disclosure, “database” is used to refer to a store of data, and not to a particular computer system, software, architecture, schema, format, etc. for holding such information. The database may also comprise a plurality of replicated databases configured to store the same data for redundancy and improved performance in access, and/or a plurality of databases configured to store different sets of data, such as entities profiles for different sets of entities, or different portions of a first entities profile (e.g., one database storing public information about the first entity, and another database storing private information about the same entity). It will be appreciated that a plurality (e.g., n number) of other entities may also be identified and inferences may be made about their roles in relation to the first entity. The plurality of other entities and their respective roles in relation to the first entity may be linked to the first entity to create a larger social network (relative to the social network created by linking the first entity to the second entity). At 112, the method 100 ends.

The information stored in the database may be retrieved by a web service that is capable of transmitting the information to a service-based application, wherein the first entity can view his/her/its social network. For example, a user may log into a social network website (e.g., by entering a username and password), wherein the social network is displayed to the first entity. The website may also be used as a mechanism for accepting/rejecting/modifying information in the database, such as inferences made at 108 and/or entities comprising the first entity's social network. Additionally, the social network may be managed by a website provider, for example, capable of managing other entities' social networks.

It will be appreciated that method 100 for determining the first entity's social network may be dynamic. For example, the first entity may manually add, remove, or modify information that has been stored about his/her/its social network (e.g., removing an entity, changing an entity's role, etc). Additionally, the social network may be modified automatically (e.g., by monitoring ping servers and crawling feeds in response to pings) to reflect updates in the one or more data sources. In one example, the first entity adds a new contact to his phone, which broadcasts a social network update. Upon receiving the update a crawler extracts the new information from the phone's phonebook, identifies a third entity, infers a role of the third entity in relation to the first entity, and links the first entity to the third entity and the third entity's role(s) in relation to the first entity. In another example, the first entity adds a calendar event that reads, “Sam and Julie getting married.” The inference component may detect that the calendar event is in regards to a second entity, previously inferred to be a co-worker, and a third entity, previously inferred to be the first entity's sister, so the inference component may update the second entity's role to include co-worker and brother-in-law.

Inferences made about other entities' social networks may also be used to make inferences with regards to the roles of entities in relation to the first entity (when they are managed by a common service). In one embodiment, the second entity also has used a method similar to method 100 to determine his/her/its social network, and inferences made about his/her/its social network may be used to make inferences about an entity's role in relation to the first entity. For example, if a fourth entity is meeting with the first entity for lunch, and the second entity's social network indicates that the fourth entity is a business client of the second entity, it may be inferred that the fourth entity is a business client of the first entity as well if it has previously been inferred that the first and second entities are co-workers. It will be appreciated that inferences made with regards to entities in the second entity's social network may also be used to modify the inferences made about the second entity's role in relation to the first entity. For example, if the second entity, inferred to be a good friend of the first entity, adds several of the same business contacts as the first entity, it may be inferred that that second entity is also and/or has become a business partner of the first entity.

It will be appreciated that the first entity's social network may be searchable. For example, if the first entity wants to find a co-worker that he worked with two years ago, the first entity may enter information about the co-worker (e.g., how long ago he worked with him, the employer's name, etc.) into a search field and a query may be conducted of the database wherein the first entity's social network is stored. Additionally, the first entity may allow other entities to access his/her/its network, wherein searches of the first entity's network may be conducted by other entities. The first entity may limit access to his/her/its social network, such as to those in his/her/its social network, to a particular set of entities in his/her/its social network, or by password protecting his/her/its network (wherein other entities enter a password before a search can be conducted). For example, the first entity may specify that anyone who has been inferred to be a current co-worker of the first entity may search the first entity's business contacts (e.g., restricting access by other entities). Additionally, the first entity may specify that his family and close friends (e.g., those whom he communicates with at least 5 times a year), for example, may search his social network for service providers (e.g., dentist, doctor, barber, etc.).

It will also be appreciated that the first entity may search other entities' social networks (when the other entities' social networks have granted the first entity access). In one example, the first entity moves to a new city and is looking for a local dentist and searches the social networks of his new co-workers to find one. The search results may display, for example, the co-worker's name, the name of the dentist, the telephone number of the dentist, the number of years the co-worker has been seeing the dentist, and/or other relevant information about the dentist that is known based on the information about the dentist included in the co-worker's social network. In one embodiment, the first entity may add a selected entity (e.g., the dentist) from another entity's social network (e.g., the co-worker) to his/her/its social network and/or data source, such as a phonebook, associated with the first entity. The mechanism that crawls the data source(s) to extract data at 104, for example, may also be responsible for inputting contact information (found in a search) into the data sources.

Additionally, if a search of the first entity's social network is conducted, the terms used to conduct the search and/or content selected as a result of a search may be used to fine-tune the inference algorithms. For example, the first entity may commonly search for “soccer” and “co-worker” together and often selects co-workers that he visits on Saturdays at noon (e.g., determined from calendar entries in the first entity's electronic calendar). Using this information, the inference component may infer that co-workers he visits on Saturdays at noon are on a soccer team with the him and may modify, for example, those entities matching that criteria to include this term into their inferred roles, in relation to the first entity.

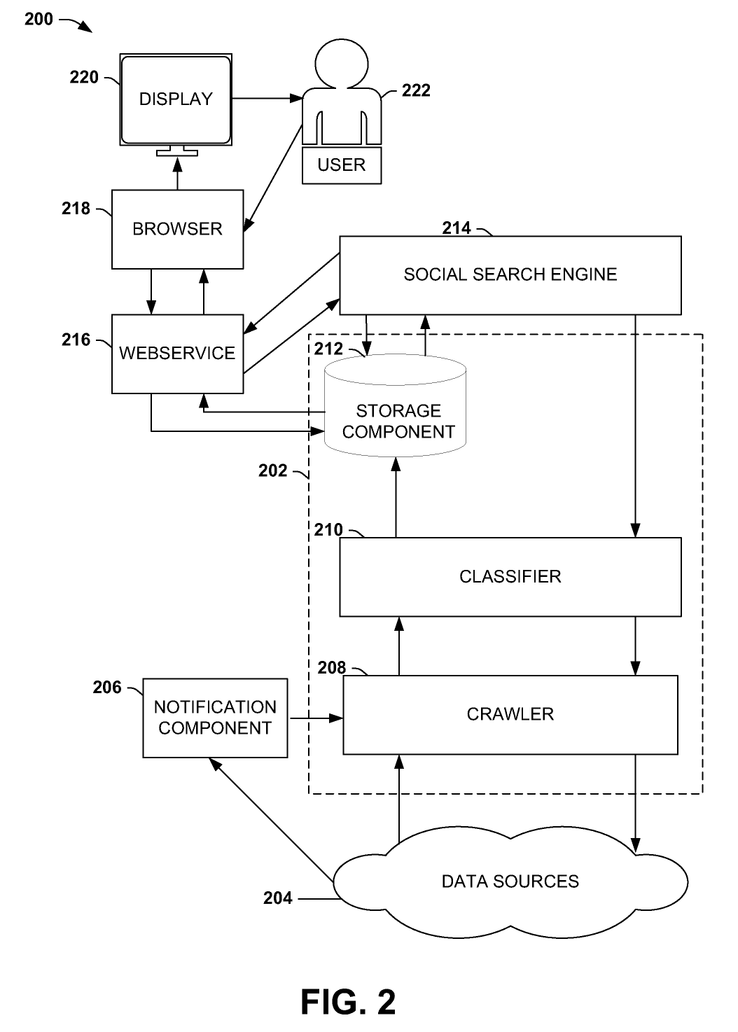

FIG. 2 illustrates an exemplary environment 200 wherein a system 202 for determining a first entity's social network may be implemented. More particularly, the system 202 illustrates a crawler 208 configured to collect data from one or more data sources 204 associated with the first entity, a classifier 210 configured to infer the role of a second entity in relation to the first entity as a function of data collected by the crawler 208, and a storage component 212 configured to determine the first entity's social network by linking the first entity to the second entity and the second entity's role in relation to the first entity to. It will be appreciated that the classifier 210 may be configured to detect the second entity prior to inferring his/her/its role in relation to the first entity.

The crawler 208 collects data from one or more data sources 204 associated with the first entity. It will be appreciated in that art that the term “crawler” is used in a broad sense herein to describe or comprise a program and/or automated script which browses the data source in a methodical, automated manner and collects data. The one or more data sources 204 may comprise personal, company, and/or public data, for example, associated with the first entity. For example, a data source may be personal information management (PIM) systems (e.g., email, phonebook, calendar, address book, to-do list, etc.), phone logs, electronic documents (e.g., word processor documents, images, etc.), instant messenger conversations, source code repositories, digital libraries, document repositories, intranet/internet pages, and/or intranet/internet web searches. It will be appreciated that the first entity may select and/or limit which data sources are used to collect data from.

In one embodiment, a notification component 206 notifies the crawler 208 when and/or which data source(s) 204 to crawl. The notification component 206 may be operated manually (e.g., the first entity clicks a button that tells the crawler to crawl) and/or automatically. In one example of an automated notification component 206, the notification component 206 monitors for pings from the one or more data sources 204. These pings indicate that content in the data sources 204 have been modified. The notification component then notifies the crawler 208 to crawl the data sources 204. If a data source 204 is not capable of sending pings, for example, the notification component 206 may notify the crawler 208 to crawl at predetermined intervals, for example. It will be appreciated that the crawler 208 may pull data from the one or more data sources 204 and/or the data may be pushed to the crawler 208 by the data sources 204.

The data collected by the crawler 208 is passed to the classifier 210. The classifier 210 may be responsible for detecting the second entity and/or inferring the role of the second entity in relation to the first entity. It will be appreciated that the second entity may be identified manually by the first entity, wherein the classifier 210 is not responsible for detecting the second entity. The classifier 210 may detect the second entity from the data collected, for example, using inference algorithms that consider the social context (e.g., meeting invitation, search result, published document), use natural language processing to detect data that resemble such things as people, organizations, business, etc., and/or that identify locations in the data source wherein entities are commonly found (e.g., a “To” field, a “subject” line, etc.). It will also be appreciated that once the second entity is detected, the classifier 210 may have the crawler 208 crawl additional data sources 204 as a function of the second entity. For example, the second entity may be detected from a calendar entry and the crawler 208 may use the name of the second entity to crawl the internet for information about the second entity, such as where he/she works and/or the second entity's type of business.

Once the second entity has been detected, the classifier 210 may use algorithms, machine learning, and/or rules to infer a role of the second entity in relation to the first entity. The algorithms may infer a role from a predefined list of roles and/or the algorithms may create roles as a function of terms in the data collected. For example, the algorithms may use the day and/or time of day the first and second entity meet/speak, terms in the data associated with the second entity, the types of relationships the first entity is likely to have, and/or whether the second entity is also linked to another entity whose role has previously been inferred.

The inferences made by the classifier 210, the second entity, and other data related to the second entity that was collected by the crawler (such as the second entities phone number, address, etc.) is transferred to the storage component 212 (e.g., a database) wherein the information is linked to other entities associated with the first entity to determine the first entities social network.

In one embodiment, the first entity's social network may be sent via a web service 216 configured to expose methods for retrieving the information stored in the storage component 212 to a browser 218, wherein information is presented to the user 222 (e.g., the first entity, a representative of the first entity, etc.) on a display 220. The browser 218 may also configured to receive input from the user 222 and relay the information, through the web service 216 to the storage component 212 and the classifier 210. For example, the user 222 may accept, deny, and/or modify the inferences made and/or the entities in his/her/its social network. In one example, the classifier 210 inferred that the second entity has been the user's barber for ten years as a function of monthly calendar entries and terms in the calendar entries. The user 222 may accept this inference and/or modify the inferred role by inputting the term “client,” (indicating that the second entity is also a client of the user first entity). The user 222 may also deny that the second entity is a part of his/her/its social network (even if the first entity and second entity have lunch weekly) and the second entity was may be excluded from the first entity's social network. It will be appreciated that other environments may also be used to present the first entity's social network to the first entity and/or another entity. For example, the social network may be displayed on a desktop application. Additionally, various other techniques/mechanisms may be employed for retrieving the first entity's social network and/or a portion of the first entity's social network from the storage component 212.

The input from the user 222 (i.e., relevance feedback) may be used by the classifier 210 to fine-tune the algorithms used to make inferences (e.g., where the algorithms are configured to use artificial intelligence techniques). For example, if the first entity alters the role of the second entity and/or rejects the second entity, the algorithms may detect patterns of rejections and/or changes to inferred roles of entities and adjust the inferences that are made accordingly.

Environment 200 may also comprise a social search engine 214 configured to conduct queries of the storage component 212 and retrieve relevant data (e.g., relevant entities and their roles in relation to the first entity). For example, the user 222 may enter terms into a search field of a webpage displayed on the browser 218 and entities with roles that match those terms may be retrieved from the storage component 212 and displayed on the webpage. It will be appreciated that the classifier 210 may also use the terms searched for to fine-tune the algorithms. It will also be appreciated the user 222 may search other entities' social networks comprised in the storage component 212 and/or other entities may search the first entity's social network (if the entities are managed by a common provider). For example, a first entity may be looking for a relocation service and may search co-workers' social networks to find one.

The scope of a search may be limited to facilitate keeping the results manageable, as well as to prevent access by unauthorized entities, for example. In one example, the search is limited as a function of the terms used in the search. For example, if the first entity is looking for a dentist, it may limit the social networks searched to those that are inferred to be relatives of the first entity and in a geographic location near the first entity (e.g., as a function of known information about the first entity). Additionally, security measures, known in the art, may be employed to limit the search capabilities of an entity. For example, an entity may restrict access to his/her/its social network, such by defining which entities may search his/her/its social network and/or password protecting the social network. In one example, the first entity specifies that only those entities that are classified as being close friends and/or relatives of the first entity may search his network.

If the first entity conducts a search of another entity's social network, the first entity may add entities found from the search into one or more data sources 204 associated with the first entity and/or add the entities to his/her/its social network. For example, if the first entity searches for and finds a dentist in another entity's social network, the first entity may select (e.g., by clicking an “add” button) the dentist and information about the dentist known the other entity (such as the dentist's telephone number) may be added to the first entity's phonebook. It will be appreciated that the crawler 208 may be responsible for importing information found in another entity's social network into the one or more data sources 204.

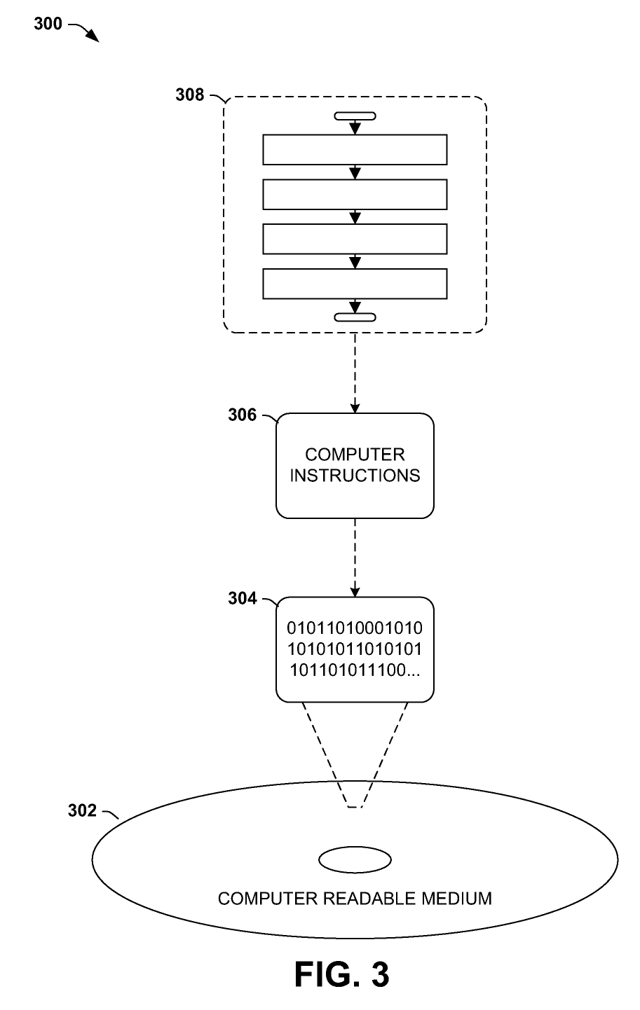

Still another embodiment involves a computer-readable medium comprising processor-executable instructions configured to implement one or more of the techniques presented herein. An exemplary computer-readable medium that may be devised in these ways is illustrated in FIG. 3, wherein the implementation 300 comprises a computer-readable medium 302 (e.g., a CD-R, DVD-R, or a platter of a hard disk drive), on which is encoded computer-readable data 304. This computer-readable data 304 in turn comprises a set of computer instructions 306 configured to operate according to one or more of the principles set forth herein. In one such embodiment 300, the processor-executable instructions 306 may be configured to perform a method, such as the exemplary methods 100 of FIG. 1, for example. In another such embodiment, the processor-executable instructions 306 may be configured to implement a system, such as the exemplary system 202 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

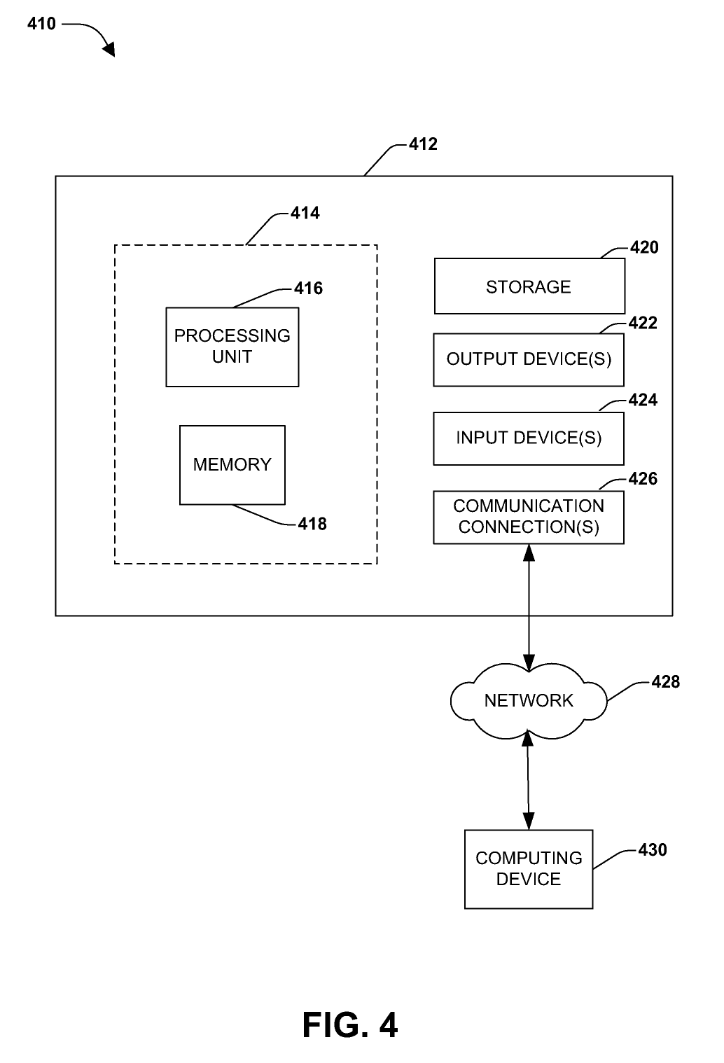

FIG. 4 and the following discussion provide a brief, general description of a suitable computing environment to implement embodiments of one or more of the provisions set forth herein. The operating environment of FIG. 4 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 4 illustrates an example of a system 410 comprising a computing device 412 configured to implement one or more embodiments provided herein. In one configuration, computing device 412 includes at least one processing unit 416 and memory 418. Depending on the exact configuration and type of computing device, memory 418 may be volatile (such as RAM, for example), non-volatile (such as ROM, flash memory, etc., for example) or some combination of the two. This configuration is illustrated in FIG. 4 by dashed line 414.

In other embodiments, device 412 may include additional features and/or functionality. For example, device 412 may also include additional storage (e.g., removable and/or non-removable) including, but not limited to, magnetic storage, optical storage, and the like. Such additional storage is illustrated in FIG. 4 by storage 420. In one embodiment, computer readable instructions to implement one or more embodiments provided herein may be in storage 420. Storage 420 may also store other computer readable instructions to implement an operating system, an application program, and the like. Computer readable instructions may be loaded in memory 418 for execution by processing unit 416, for example.

The term “computer readable media” as used herein includes computer storage media. Computer storage media includes volatile and nonvolatile, removable and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 412. Any such computer storage media may be part of device 412.

Device 412 may also include communication connection(s) 426 that allows device 412 to communicate with other devices. Communication connection(s) 426 may include, but is not limited to, a modem, a Network Interface Card (NIC), an integrated network interface, a radio frequency transmitter/receiver, an infrared port, a USB connection, or other interfaces for connecting computing device 412 to other computing devices. Communication connection(s) 426 may include a wired connection or a wireless connection. Communication connection(s) 426 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 412 may include input device(s) 424 such as keyboard, mouse, pen, voice input device, touch input device, infrared cameras, video input devices, and/or any other input device. Output device(s) 422 such as one or more displays, speakers, printers, and/or any other output device may also be included in device 412. Input device(s) 424 and output device(s) 422 may be connected to device 412 via a wired connection, wireless connection, or any combination thereof. In one embodiment, an input device or an output device from another computing device may be used as input device(s) 424 or output device(s) 422 for computing device 412.

Components of computing device 412 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 412 may be interconnected by a network. For example, memory 418 may be comprised of multiple physical memory units located in different physical locations interconnected by a network.

Those skilled in the art will realize that storage devices utilized to store computer readable instructions may be distributed across a network. For example, a computing device 430 accessible via network 428 may store computer readable instructions to implement one or more embodiments provided herein. Computing device 412 may access computing device 430 and download a part or all of the computer readable instructions for execution. Alternatively, computing device 412 may download pieces of the computer readable instructions, as needed, or some instructions may be executed at computing device 412 and some at computing device 430.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for determining a first entity's social network, comprising:
extracting data from one or more data sources associated with the first entity;
identifying a second entity;
inferring a role of the second entity in relation to the first entity as a function of the data extracted from the one or more data sources; and
determining the first entity's social network by linking the first entity to the second entity and the second entity's role in relation to the first entity.

2. The method of claim 1, wherein the role comprises at least one of the following: a biological role; business role; social hierarchical role; and a social role.

3. The method of claim 1, wherein the role of the second entity is identified using inference algorithms that infer the role of the second entity as a function of the information extracted from the data source.

4. The method of claim 3, wherein the inference algorithms are designed using at least one of: machine learning; natural language processing; and artificial intelligence.

5. The method of claim 4, wherein the inference algorithms are trained as a function of a first entity's input.

6. The method of claim 1, comprising linking the first entity to n number of entities and the entities' roles in relation to the first entity by extracting data, identifying the n number of entities and inferring the entities' roles.

7. The method of claim 1, comprising conducting a search of the second entity's social network by the first entity.

8. The method of claim 7, comprising selecting an entity from the second entity's social network and adding the selected entity to the first entity's social network.

9. The method of claim 1, comprising receiving approval from the first entity before linking the second entity and the second entity's role in relation to the first entity to a third entity and the third entity's role in relation to the first entity.

10. The method of claim 1, comprising detecting supplementary information about the second entity from the data extracted from the one or more data sources associated with the first entity.

11. The method of claim 10, the supplementary information comprising at least one of: contact information; geographic location; and demographic information.

12. The method of claim 1, wherein the second entity is identified as a function of the data extracted from the one or more data sources associated with the first entity.

13. The method of claim 1, wherein the one of more data sources is at least one of the following: private electronic documents; private resources; personal devices; personal information management systems; corporate electronic documents; corporate resources; corporate information systems; public electronic documents; public resources; and search results.

14. A system for determining a first entity's social network, comprising:
a crawler configured to collect data from one or more data sources associated with the first entity;
a classifier configured to infer the role of a second entity in relation to the first entity as a function of data collected by the crawler; and
a storage component configured to determine the first entity's social network by linking the first entity to the second entity and the second entity's role in relation to the first entity.

15. The system of claim 14, the classifier configured to detect the second entity prior to inferring the role of the second entity in relation to the first entity.

16. The system of claim 14, the crawler configured to receive notifications from the one or more data sources when data in the one or more data sources is modified.

17. The system of claim 16, the one or more data sources configured to notify the crawler when modifications have been made to data associated with the one or more data sources.

18. The system of claim 14, comprising a social search engine configured to search the storage component and select entities from the first entity's social network that relate to terms used to conduct the search.

19. The system of claim 14, the crawler configured to extract data from one or more data sources as a function of an entity selected by the first entity from another entity's social network, wherein the first entity conducted a search of another entity's social network.

20. A method of determining a first entity's social network, comprising:
extracting data from one or more data sources associated with the first entity,
wherein the one or more data sources is at least one of the following: private electronic documents; private resources; personal devices; personal information management systems; corporate electronic documents; corporate resources; corporate information systems; public electronic documents; public resources; and search results;
identifying a second entity;
inferring a role of the second entity in relation to the first entity as a function of the data extracted from the one or more data sources,
wherein the role of the second entity is identified using inference algorithms,
wherein the inference algorithms are designed using at least one of: natural language processing; artificial intelligence; machine learning;
determining the first entity's social network by linking the first entity to the second entity and the second entity's role in relation to the first entity; and
conducting a search of one or more entities' social network,
wherein an entity selected from a different entity's social network is added to a data source of the entity conducting the search.
